(19) United States
(12) Patent Application Publication
(10) Pub. No.: US 2026/0361660 A1
(43) Pub. Date: Nov. 12, 2026

(54) METHOD AND SYSTEM FOR MANAGING AUDIO PACKETS DURING TRANSMISSION

(71) Applicant: SAMSUNG ELECTRONICS CO., LTD., Suwon-si (KR)

(72) Inventors: Siddhesh Chandrashekhar GANGAN, Bangalore (IN); Ramyashree M, Bangalore (IN); Siddharth Sethi, Bangalore (IN); Bhavin Shah, Bangalore (IN); Tushar Rain, Bangalore (IN)

(73) Assignee: SAMSUNG ELECTRONICS CO., LTD., Suwon-si (KR)

(21) Appl. No.: 19/668,433

(22) Filed: May 5, 2026

Related U.S. Application Data
(63) Continuation of application No. PCT/KR2026/095847, filed on Apr. 13, 2026.

(30) Foreign Application Priority Data
May 9, 2025 (IN) 202541045076

(51) Int. Cl. H04L 47/283; H04L 65/1101; H04L 65/65

(52) U.S. Cl. CPC H04L 47/283; H04L 65/1101; H04L 65/65

(57) ABSTRACT

A method for managing audio packets during an audio transmission may be provided. The method may include detecting a beginning of a slow reception phase based on an audio packet reception rate associated with a plurality of audio packets received by the electronic device. The method may include storing at least one audio packet received during the slow reception phase from among the plurality of audio packets. The method may include detecting an end of the slow reception phase based on a change in the audio packet reception rate. The method may include rendering an audio packet from among the stored at least one audio packet based on at least one of a status of the slow reception phase, and a number of the stored at least one audio packet.

### CROSS-REFERENCE TO RELATED APPLICATIONS

This application is a continuation of International Application No. PCT/KR2026/095847, filed on Apr. 13, 2026, in the Korean Intellectual Property Receiving Office, which is based on and claims priority to Indian Patent Application Number 202541045076 filed on May 9, 2025, in the Indian Office of the Controller General of Patents, Designs and Trade Marks, the disclosures of which are incorporated by reference herein in their entireties.

### BACKGROUND

### 1. Field

The disclosure generally relates to the field of audio transmission and more particularly, to a method and a system for managing audio packets during slow audio reception phases.

### 2. Description of Related Art

During real-time communication between a pair of electronic devices connected wirelessly using communication standards or protocols such as Voice over Long-Term Evolution (VoLTE) or Voice over New Radio (VoNR), network data transmission speeds may be highly unpredictable and may vary depending upon network conditions.

During an audio transmission such as a real-time voice call, delay at the receiver device may lead to degradation of the audio quality at the receiver device during rendering/playback. For example, when the delayed packets are fed to a voice encoder and decoder (vocoder) in an irregular manner due to the inter-arrival delay or the sudden burst, an unnatural or robotic-sounding audio (which may be referred to as robotic noise) may be generated, which may degrade an audio experience and may also lead to loss of important audio data.

Due to variable and unpredictable network conditions, the rate of arrival of audio packets at the receiver device may not be consistent. As a result, an undesirable noise may appear in the audio being transmitted when rendered. Further, there may be appearance of undesired artifacts in the audio stream such as intermittent/choppy playout causing noisy audio, highly delayed playout due to previously delayed packets, and the like. Further, playing all the packets which are received in burst may also introduce significant end-to-end delay in the audio stream, because the received packets may already be delayed.

In wireless audio transmission, jitter may refer to a variation in a time-delay between a time at which a signal is transmitted and a time at which the signal is received. Jitter may be a measure of a variability in time-delay in receiving the transmitted signal over the network. Further, inter-arrival time may refer to a time between arrival of consecutive packets at a receiving device, and transit time may refer to a time used by the signal to travel from transmitter device to the receiver device (e.g., a time difference between a time at which the packet is sent from the transmitter device and a time at which the packet is received by the receiver device). The time delay may be attributed to at least one of network congestion, poor hardware performance, and packet prioritization policies. The delay may directly affect the quality of the audio at the receiver device. For example, the longer the delay, the more is the likelihood of a choppy audio.

When the audio packets are received with uneven inter-arrival delay, some jitter buffer controllers may try to play the packets at an even interval, which may for example be an interval generated interval at the transmitter device. However, if packets are generated with a particular inter-arrival delay of and received with a higher inter-arrival delay, playback of these packets may cause audio distortion, which may be perceived by a user of the receiver device as robotic or choppy.

Therefore, there is a need for a system and a method to overcome the above-mentioned problems and other associated problems in overcoming the problem of noise generated as a result of network conditions.

### SUMMARY

In accordance with an aspect of the disclosure, a method performed by an electronic device may be provided. The method may include detecting a beginning of a slow reception phase based on an audio packet reception rate associated with a plurality of audio packets received by the electronic device. The method may include storing at least one audio packet received during the slow reception phase from among the plurality of audio packets. The method may include detecting an end of the slow reception phase based on a change in the audio packet reception rate. The method may include rendering an audio packet from among the stored at least one audio packet based on at least one of a status of the slow reception phase, and a number of the stored at least one audio packet.

In accordance with an aspect of the disclosure, an electronic device may be provided. The electronic device may include memory storing instructions. The electronic device may include at least one processor operatively coupled to the memory and comprising processing circuitry. The at least one processor may individually or collectively execute the instructions to cause the electronic device to detect a beginning of a slow reception phase based on an audio packet reception rate associated with a plurality of audio packets received by the electronic device. The at least one processor may individually or collectively execute the instructions to cause the electronic device to store at least one audio packet received during the slow reception phase from among the plurality of audio packets. The at least one processor may individually or collectively execute the instructions to cause the electronic device to detect an end of the slow reception phase based on a change in the audio packet reception rate. The at least one processor may individually or collectively execute the instructions to cause the electronic device to render an audio packet from among the stored at least one audio packet based on at least one of a status of the slow reception phase, and a number of the stored at least one audio packet.

In accordance with an aspect of the disclosure, a computer-readable storage medium configured to store at least one instruction, which, when executed by at least one processor individually or collectively, may cause an electronic device to perform the method.

### BRIEF DESCRIPTION OF THE DRAWINGS

The above other features, aspects, and advantages of an embodiment of the disclosure will more apparent from the following detailed description taken in conjunction with the accompanying drawings in which like characters represent like parts throughout the drawings, in which:

FIGS. 1A-1D depict methods for managing audio packets during an audio transmission, according to an embodiment of the disclosure;

FIG. 2 illustrates an environment including a system for managing audio packets during an audio transmission over a network, according to an embodiment of the disclosure;

FIG. 3A illustrate a process flow for a determining module of the system for managing the audio packets, according to an embodiment of the disclosure;

FIG. 3B illustrate an exemplary process flow for the system for managing the audio packets, according to an embodiment of the disclosure;

FIG. 4 illustrates a process flow describing the functioning of a rendering module of the system for managing the audio packets, according to an embodiment of the disclosure;

FIG. 5 illustrates the concept of reducing the delay and the method of latency-recovery achieved by the system for managing the audio packets, according to an embodiment of the disclosure; and

FIG. 6 is a flowchart illustrating a method for managing the audio packets during the audio transmission over the network, according to an embodiment of the disclosure.

Further, skilled artisans will appreciate that elements in the drawings are illustrated for simplicity and may not have necessarily been drawn to scale. For example, the flow charts illustrate the method in terms of some of the steps or operations involved to help to improve understanding of aspects of the disclosure. Furthermore, in terms of the construction of the device, one or more components of the device may be represented in the drawings by particular symbols, and the drawings may show only some details that are pertinent to understanding the embodiments of the disclosure so as not to obscure the drawings with details that will be readily apparent to those of ordinary skill in the art having the benefit of the description herein. It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

### DETAILED DESCRIPTION

For the purpose of promoting an understanding of the principles of the disclosure, reference will now be made to the various embodiments, and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all”. Accordingly, the terms “more than one”, “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments”.

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein such as but not limited to “includes”, “comprises”, “has”, “consists”, “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include”.

Whether or not a certain feature or element was limited to being used only once, either way, it may still be referred to as “one or more features”, “one or more elements”, “at least one feature”, or “at least one element”. Furthermore, the use of the terms “one or more” or “at least one” feature or element does not preclude there being none of that feature or element unless otherwise specified by limiting language such as “there needs to be one or more ” or “one or more element is required”.

As used herein, expressions such as “at least one of”, when preceding a list of elements, modify the entire list of elements and do not modify the individual elements of the list. For example, the expression, “at least one of A, B, and C”, should be understood as including only A, only B, only C, both A and B, both A and C, both B and C, or all of A, B, and C.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

Unless otherwise defined, all terms, and especially any technical and/or scientific terms, used herein may be taken to have the same meaning as commonly understood by one having ordinary skill in the art.

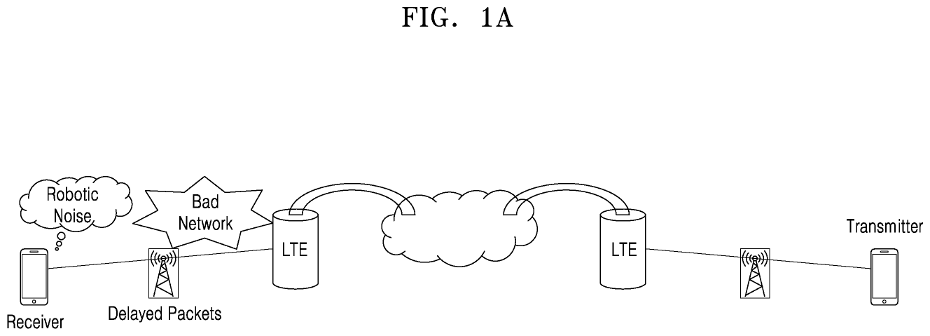

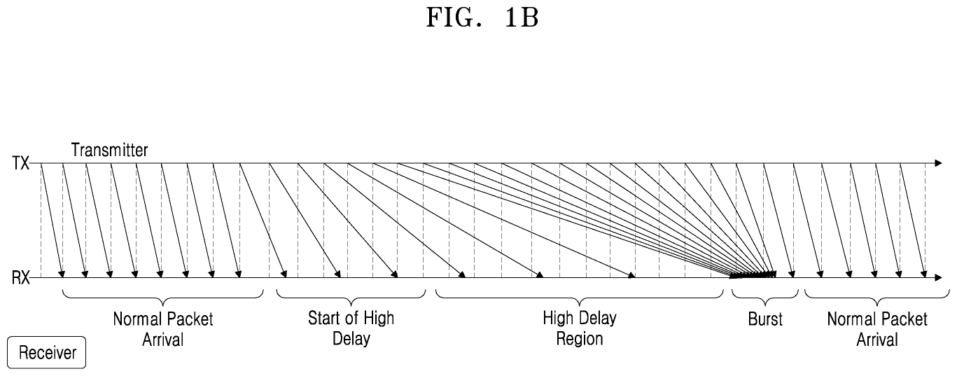

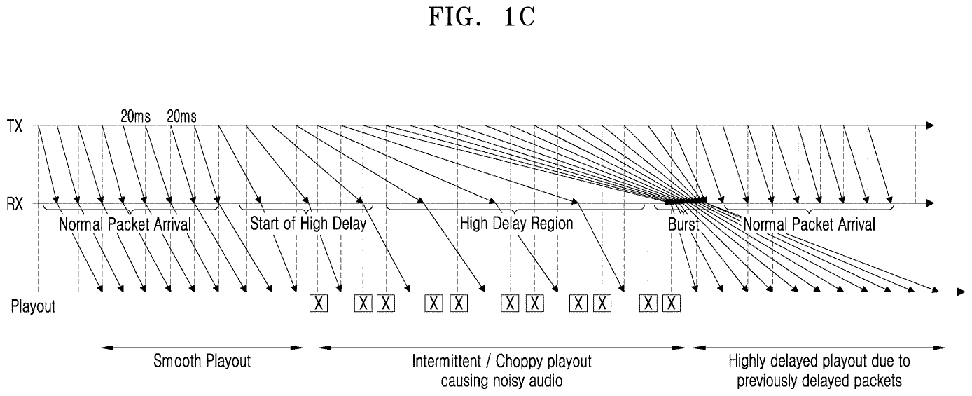

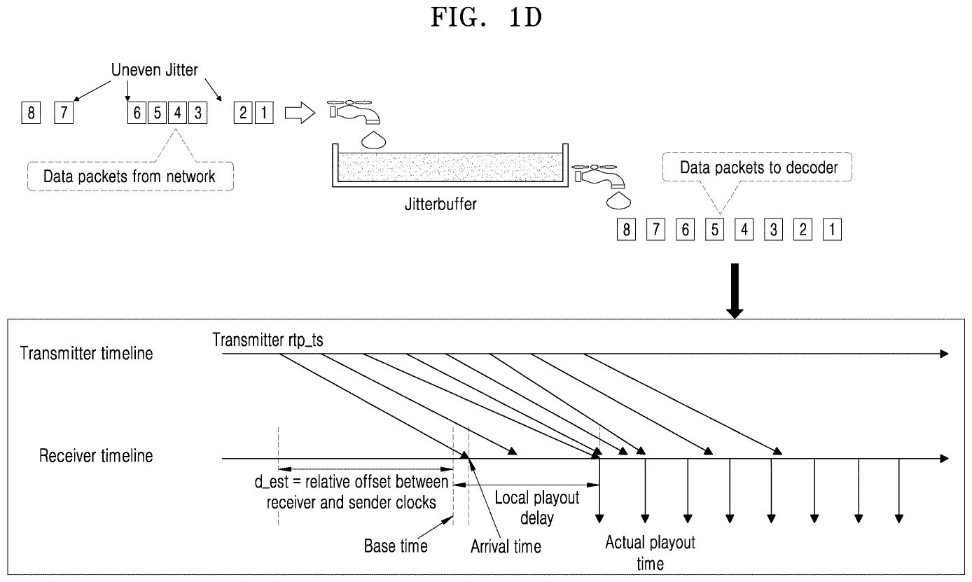

FIG. 1A shows a data transmission architecture or framework, according to an embodiment of the disclosure. Due to network congestion or bad network conditions in a network used by a transmitter device and a receiver device, which may for example be a Long-Term Evolution (LTE) network, the reception of data packets at a receiving device may be delayed.

FIG. 1B illustrates the delay in packet arrival at a receiver device due to variable network conditions, according to an embodiment of the disclosure.

FIG. 1C illustrates an example of a transmission of audio between a transmitter device and a receiver device, according to an embodiment of the disclosure, and further illustrates examples of the undesirable artifacts generated at the receiver device due to unpredictable network conditions.

FIG. 1D illustrates some techniques for jitter buffer management, according to an embodiment of the disclosure, wherein the purpose is to evenly playout the audio data packets received at the receiver device. As discussed above, if packets are generated with a particular inter-arrival delay of (e.g., 20 ms) and received with a higher inter-arrival delay (e.g., greater than 80 ms), playback of these packets may cause audio distortion, which may be perceived by a user of the receiver device as robotic or choppy, as illustrated in FIG. 1C.

Accordingly, embodiments may provide methods, devices, and systems which may overcome the above-mentioned problems and other associated problems in overcoming the problem of noise generated as a result of network conditions.

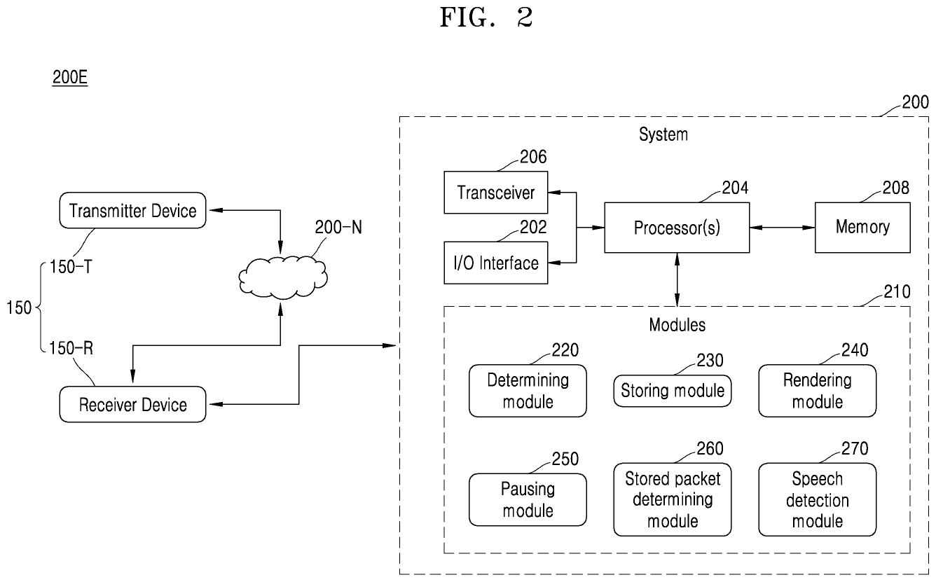

FIG. 2 illustrates an environment 200E including a system 200 for managing audio packets during an audio transmission over a network 200-N, according to an embodiment of the disclosure. The network 200-N may be a wireless network connecting a pair of devices 150 (or the devices 150), which may include for example a receiver device 150-R and a transmitter device 150-T. The receiver device 150-R or the transmitter device 150-T may be referred to an electronic device. The audio transmission may be a wireless transmission using communication standards/protocols such as Voice over Long-Term Evolution (VoLTE), Voice over New Radio (VoNR), and the like.

The wireless transmission may be a voice call made from the transmitter device 150-T to the receiver device 150-R. The receiver device 150-R may belong to or be used by a user receiving the voice call. Similarly, the transmitter device 150-T may belong to or be used by a user making the call over a wireless communication system of the network 200-N. According to an embodiment of the disclosure, one or both the devices 150 may be feature phones, a smartphones, or any other electronic device having audio transmission capabilities such as call-making over the network 200-N, such as a wireless network.

According to an embodiment of the disclosure, the system 200 may be included in or implemented by the receiver device 150-R, or another electronic device that is associated with the receiver device 150-R, but embodiments are not limited thereto. The system 200 may include a plurality of modules 210 including a determining module 220, a storing module 230, and a rendering module 240. According to an embodiment of the disclosure, the system also may include a pausing module 250, a stored packet determining module 260, and a speech detection module 270. The determining module 220 may be configured to determine or detect, by the receiver device 150-R, a beginning of a slow reception phase of the audio transmission based on a rate of audio packet reception (which may be referred to as an audio packet reception rate) at the receiver device 150-R. The slow reception phase may refer to the duration of the audio transmission during which the audio packets are not received uniformly at the receiver device 150-R. For example, there may be an observed time-delay associated with the reception of the audio packets at the receiver device 150-R. The time delay may be caused by network congestion, poor hardware performance, improper implementation of packet prioritization, and the like. The audio quality of the play-back at the receiver device 150-R may be affected during the slow reception phase.

The slow reception phase may be determined or detected based on factors such as an inter-arrival time delay, jitter, transit time and the like, associated with the reception of the packets at the receiver device 150-R. The inter-arrival time delay may be a measure of the time elapsed between receiving of the consecutive packets at the receiver device 150-R. Jitter may be a measure of the variation in time elapsed between when a signal is transmitted by the transmitter device 150-T and when the signal is received at the receiver device 150-R. Further, transit time may be the time elapsed between when the packet is sent from the transmitter device 150-T and the time when the packet is received at the receiver device 150-R. For example, jitter may be represented by a jitter estimator formula, wherein the value D(i−1, i) is the difference of relative transit times for two packets. The difference is computed according to Equation 1 below:

D(i, j)=(Rj−Ri)−(Sj−Si)=(Rj−Sj)−(Ri−Si) (1)

In Equation 1 above, Si may denote a timestamp of a packet i, Ri may denote the time of arrival for packet i, Sj may denote a timestamp of a packet j, and Rj may denote the time of arrival for packet j. Further, the storing module 230 may be configured to store, by the receiver device 150-R, at least one of the audio packets received during the slow reception phase. Subsequently, the determining module 220 may be configured to determine or detect, by the receiver device 150-R, an end of the slow reception phase based on change in the rate of audio packet reception.

Furthermore, the rendering module 240 may be configured to render, by the receiver device 150-R, one or more stored audio packets based on at least one of a status of the slow reception phase and a number of the stored audio packets. For example, the rendering module 240 may be configured to render the stored audio packets at the receiver device 150-R based on the status of the slow reception phase. As another example, the rendering module 240 may be configured to render the stored audio packets at the receiver device 150-R based on the number of the stored audio packets. As yet another example, the rendering module 240 may be configured to render the stored audio packets at the receiver device 150-R based on both the status of the slow reception phase and the number of the stored audio packets.

According to an embodiment of the disclosure, the system 200 may include at least one processor 204, a memory 208, a transceiver 206, and an input/output (I/O) interface 202. The processor 204 may be disposed in communication with a communication network via a network interface. According to an embodiment of the disclosure, the network interface may be or may include the I/O interface 202. According to an embodiment of the disclosure, the network interface may connect to the network to enable the connection of the system 200 with the receiver device 150-R. The network interface may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 200 may communicate with other devices. The network interface may employ connection protocols including, but not limited to, direct connect, Ethernet (e.g., twisted pair 10/100/1000 Base T), transmission control protocol/internet protocol (TCP/IP), token ring, Institute of Electrical and Electronics Engineers (IEEE) 702.11a/b/g/n/x, etc.

According to an embodiment of the disclosure, the memory 208 may be communicatively coupled to the processor 204. The memory 208 may be configured to store data, and instructions executable by the processor 204. The memory 208 may store instructions. As an example, the memory 208 may be provided within the receiver device 150-R. According to an embodiment of the disclosure, the memory 208 may be provided within the system 200 being remote from the receiver device 150-R. As another example, the memory 208 may communicate with the processor 204 via a bus within the system 200. As yet another example, the memory 208 may be located remotely from the processor 204 and may be in communication with the processor 204 via a network. The memory 208 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 208 may include a cache or random-access memory for the processor 204. In other example, the memory 208 is separate from the processor 204, such as a cache memory of a processor, the system memory, or other memory. The memory 208 may be an external storage device or database for storing data. The memory 208 may be operable to store instructions executable by the processor 204. The functions, acts, or tasks illustrated in the figures or described may be performed by the programmed processor 204 for executing the instructions stored in the memory 208. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

The processor 204 may write data to the memory 208 or read data stored in the memory 208. In particular, the processor 204 may process data according to defined operation rules or an artificial intelligence (AI) model by executing a program or at least one instruction stored in the memory 208. Accordingly, the processor 204 may perform operations described in the following embodiments, and unless otherwise specified, operations described as being performed by the electronic device 150 or by components included in the electronic device 150 may be understood as being performed by the processor 204.

The memory 208 may be a component configured to store various programs or data, and may include a storage medium such as a read-only memory (ROM), random access memory (RAM), hard disk, CD-ROM, DVD, or a combination of such storage media. The memory 208 may not be implemented as a separate component but may be integrated into the processor 204. The memory 208 may include volatile memory, non-volatile memory, or a combination of volatile and non-volatile memory. A program or at least one instruction for performing operations according to the embodiments described below may be stored in the memory 208. The memory 208 may also provide the stored data to the processor 204 in response to a request from the processor 204.

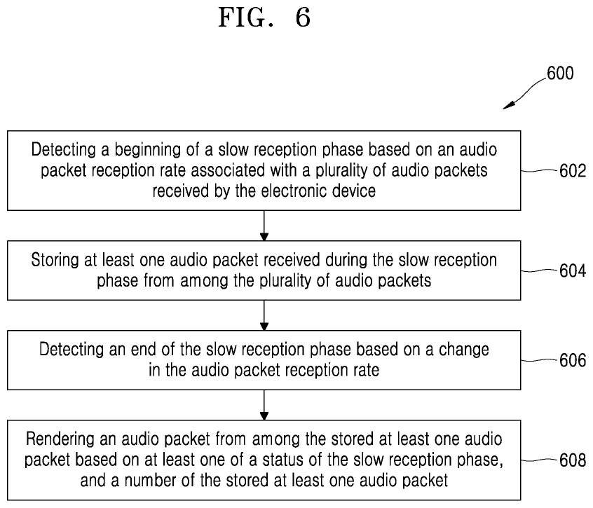

According to an embodiment of the disclosure, the plurality of modules 210 may be included within the memory 208. The plurality of modules 210 may include a set of instructions that may be executed by the processor 204 to cause the system 200 to perform any one or more of the methods/processes disclosed herein. The plurality of modules 210 may be configured to perform steps or operations described in the disclosure using the data stored in the database within the memory 208. For example, the plurality of modules 210 may be configured to perform the steps or operations disclosed with reference to FIG. 6. According to an embodiment of the disclosure, each of the plurality of modules 210 may be a hardware unit that may be outside the memory 208. According to an embodiment of the disclosure, the plurality of modules 210 may partially be implemented in hardware (e.g., sensors) and partially in software instructions embedded within a storage device (e.g., memory 208).

At least one of the plurality of modules 210 may be implemented using an artificial intelligence (AI) model or a machine learning model. For example, according to an embodiment of the disclosure, the storing module 230 and the speech detection module 270 are configured to apply the AI or machine learning models to determine aspects related to the audio packets being transmitted such as presence of speech content and a characteristic of the speech content detected. A function associated with the AI models may be performed using a memory 208 (including a non-volatile memory and/or a volatile memory) and a processor 204.

The processor 204 may include one or a plurality of processors. For example, one or a plurality of processors may be or may include a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). At least one processor included in the processor 204 may include processing circuitry. The at least one processor included in the processor 204 may execute instructions stored in the memory 208, individually or collectively. The one or a plurality of processors control the processing of the input data in accordance with a predetermined operating rule or the AI model stored in the non-volatile memory and the volatile memory. The predetermined operating rule or the AI model may be provided through training or learning. Here, being provided through learning may mean that, by applying a learning technique to a plurality of learning data, a predetermined operating rule or AI model of a desired characteristic is made. The learning may be performed in a device itself in which AI according to an embodiment is performed, and/or may be implemented through a separate server/system.

The AI model may include a plurality of neural network layers. Each layer has a plurality of weight values and performs a layer operation through calculation of a previous layer and an operation of a plurality of weights. Examples of neural networks include, but are not limited to, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Generative Adversarial Networks (GAN), and deep Q-networks.

The learning technique may be a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. According to an embodiment of the disclosure, the storing module 230 and the speech detection module 270 may be pretrained.

The AI model may be obtained by training. Here, “obtained by training” may mean that a predetermined operation rule or AI model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction may refer to a technique of logical reasoning and predicting by determining information and includes, e.g., knowledge-based reasoning, optimization prediction, preference-based planning, or recommendation.

Further, the memory 208 may include an operating system for performing one or more tasks of the system 200, as performed by a generic operating system. Each of the modules 210 may be in communication with one another and the processor 204. The working and functioning of the plurality of modules 210 of the system 200 have been described in detail with reference to the following Figures. According to an embodiment of the disclosure, the system 200 may be located within the receiver device 150-R.

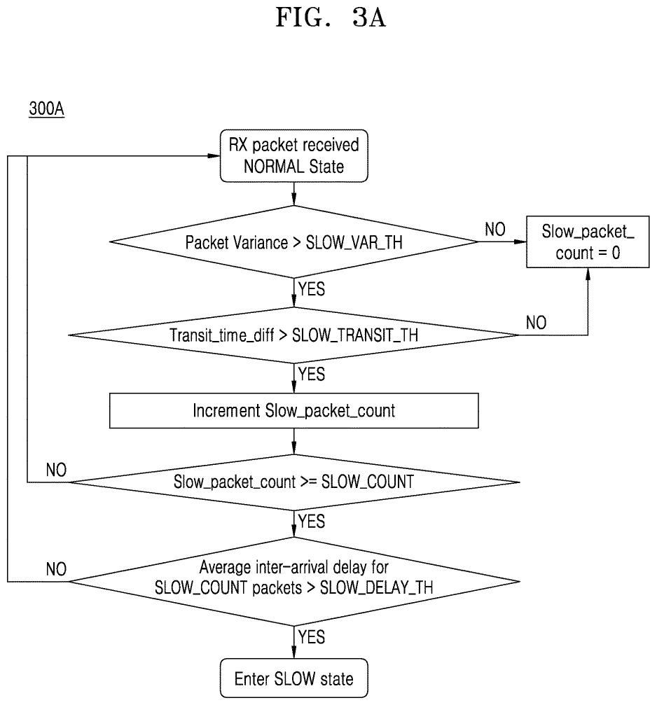

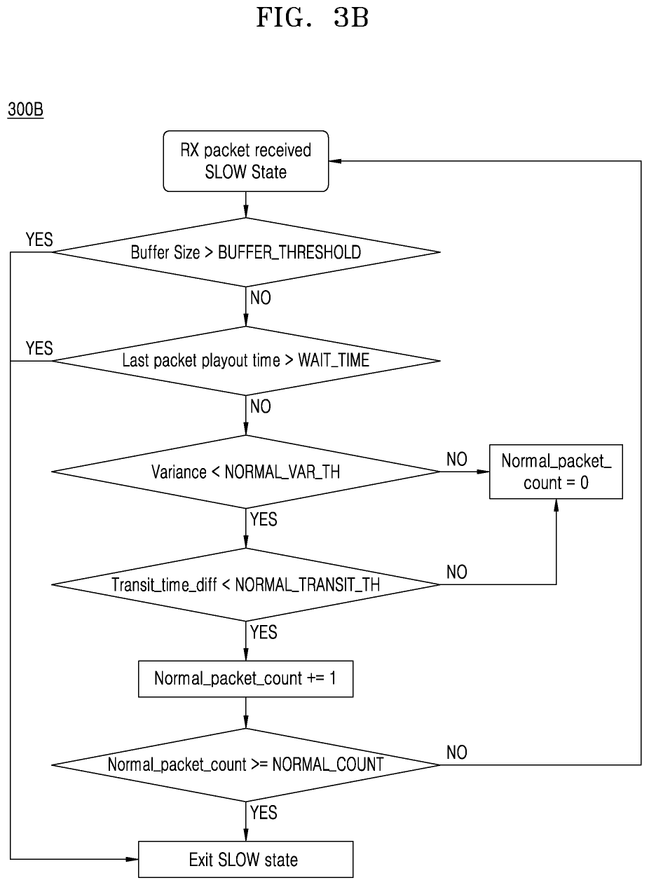

FIG. 3A illustrate a process flow 300A for the determining module 220 of the system 200, according to an embodiment of the disclosure. According to an embodiment of the disclosure, the determining module 220 may continually or continuously compare the inter-arrival time delay associated with receiving of the audio packets at the receiver device 150-R with the predetermined minimum threshold inter-arrival time delay value (which may be referred to as a predetermined minimum threshold value). Subsequently, the determining module 220 may detect or mark the beginning of the slow reception phase when the inter-arrival time delay is more than the predetermined minimum threshold inter-arrival time delay value.

For example, with reference to FIG. 3A, an exemplary technique associated with the process flow 300A may be represented as below:
For SLOW_COUNT number of consecutive packets, following conditions should be TRUE:
   1. Current packet variance >SLOW_VAR_TH and
   2. (Current packet transit time-previous packet transit time)>SLOW_TRANSIT_TH

SLOW_TRANSIT_TH may refer to a minimum difference in the transit time of consecutive packets received at the receiver device 150-R. If above conditions are true, the system 200 may be configured to determine and mark the beginning of the slow reception phase. Specifically, the system 200 may be configured to transition from a NORMAL state to SLOW state (e.g., the slow reception phase). With reference to the above exemplary algorithm, SLOW_COUNT may refer to a number of consecutive packets, and SLOW_VAR_TH may refer to minimum variance to detect SLOW mode and may be the predetermined minimum threshold inter-arrival time delay value.

In the exemplary embodiment as illustrated in FIG. 3A, a current packet variance may be calculated for each packet for determining an estimate of the inter-arrival time delay. If the current packet variance is greater than the SLOW_VAR_TH, then the corresponding packet may be determined to have been received with a delay which may be considered for determination or detection of the slow reception phase or the SLOW mode by the determining module 220. It may be appreciated that, herein, the predetermined minimum threshold inter-arrival time delay value is the SLOW_VAR_TH and increasing any one of the SLOW_COUNT or SLOW_VAR_TH, increases the strictness for entering SLOW state/mode. An increase in the SLOW_TRANSIT_TH value, may add to the strictness for entering the SLOW state and threshold values such as SLOW_TRANSIT_TH are configurable and may be configured as per requirement. The threshold values may be tuned to determine the strictness of conditions for entering the SLOW state. Specifically, the predetermined minimum threshold inter-arrival time delay value may be configurable based on the configuration of the network 200-N and the devices 150.

According to an embodiment of the disclosure, an increasing trend in transit time difference between a current packet and a previous packet may be an indication of increasing delay associated with reception of packets. If the transit time difference is more than SLOW_TRANSIT_TH for each SLOW_COUNT number of packets, then the determining module 220 may be configured to mark the beginning of the SLOW mode (or the slow reception phase).

Accordingly, according to an embodiment of the disclosure, the determining module 220 may be configured to determine a trend in transit times associated with the receiving of the audio packets at the receiver device 150-R. Subsequently, the determining module 220 may be configured to mark or detect the beginning and end of the slow reception phase based on the determined trend. Packets received in burst have a decreasing trend of transit times for consecutive packets, whereas packets received at regular interval have same or similar transit times, with some fluctuation in a specific range. The determining module 220 takes into account such factors for marking the beginning and the end of the slow reception phase. According to an embodiment of the disclosure, the determining module 220 is configured to use AI models for determining the trends in the transit times.

An exemplary algorithm may be represented in pseudo-code as below:
If “packet_var>SLOW_VAR_TH” AND “transit_diff>SLOW_TRANSIT_TH”
   increment “slow_packet_count” by 1
   if “slow_packet_count”>SLOW_COUNT
      if “avg_inter_arrival_delay”>SLOW_DELAY_TH
         ENTER SLOW State
Else
   reset “slow_packet_count” to 0

The storing module 230 may be configured to store the audio packets received during the slow reception phase at the receiver device 150-R. According to an embodiment of the disclosure, the storing module 230 may store the audio packets received from the beginning of the slow reception phase. According to an embodiment of the disclosure, the storing module 230 may store the audio packets received after the beginning of the slow reception phase.

According to an embodiment of the disclosure, the system 200 may further include a pausing module 250 configured to pause a current rendering of audio packets by the receiver device 150-R upon marking of the beginning of the slow reception phase. According to an embodiment of the disclosure, the pausing module 250 may be configured to pause the rendering at the beginning of the slow reception phase. According to an embodiment of the disclosure, the pausing module 250 may be configured to pause the rendering after the beginning of the slow reception phase. According to an embodiment of the disclosure, the pausing module 250 may be configured to pause the current rendering of the audio packets after elapse of a predetermined time from the marking of the beginning of the slow reception phase.

According to an embodiment of the disclosure, the system 200 may further include a stored packet determining module 260 configured to determine the number of the stored audio packets stored by the storing module 230 at the receiver device 150-R. According to an embodiment of the disclosure, the stored packet determining module 260 may be configured to determine the number of audio packets stored by the storing module 230 at the receiver device 150-R since the marking of the beginning of the slow reception phase. According to an embodiment of the disclosure, the stored packet determining module 260 may be configured to determine the number of audio packets stored during the entire duration of the slow reception phase.

In order to avoid buffering/storing of the audio packets for long durations, the rendering module 240 may be configured to play the stored audio packets after a sufficient number of the audio packets are stored by the storing module 230. Accordingly, the rendering module 240 may be configured to render the one or more of the stored audio packets based on a comparison of the determined number of the stored audio packets with a predetermined audio packet number. According to an embodiment of the disclosure, the predetermined audio packet number may be pre-fed/input to the system 200 based on the configuration of the devices 150. According to an embodiment of the disclosure, the threshold of number of packets stored before starting to play the packets may be dynamically determined according to need. Specifically, according to an embodiment of the disclosure, the predetermined audio packet number may be dynamically determined based on a time duration having elapsed since the beginning of the slow reception phase and the current rate of audio packet reception at the receiver device.

FIG. 3B illustrate an exemplary process flow 300B for the system 200, according to an embodiment of the disclosure. The determining module 220 may determine the end of the slow reception phase based on change in the rate of audio packet reception at the receiver device 150-R. According to an embodiment of the disclosure, the determining module 220 may be configured to determine the end of the slow reception phase based on the number of stored audio packets. According to an embodiment of the disclosure, the determining module 220 may be configured to determine the end of the slow reception phase based on both the change in the rate of audio packet reception and the number of stored audio packets at the receiver device 150-R.

An exemplary algorithm for the process flow 300B may be represented in pseudo-code as below:
BURST_OR_NORMAL_PACKET_ARRIVAL:
For NORMAL_COUNT number of consecutive packets following condition should be TRUE
   1. Current packet variance <NORMAL_VAR_TH, and
   2. (Current packet transit time-previous packet transit time)<NORMAL_TRANSIT_TH

Based on the two conditions above, a burst or normal arrival of packet may be determined or detected. Further, another exemplary algorithm may be represented in additional pseudo-code as below:
When in SLOW Mode
   1. Add received RTP packets in Buffer
   2. If BURST_OR_NORMAL_PACKET_ARRIVAL is TRUE:
      Transition from SLOW to NORMAL state
      Start playing packets in buffer
   3. If Buffer Size>BUFFER_THRESHOLD:
      Transition from SLOW to NORMAL state
      Start playing packets in buffer
   4. If Time since last buffered packet>WAIT_TIME:
      Transition from SLOW to NORMAL state
      Start playing packets in buffer

In the example above, Buffer may refer to the stored audio packets as stored by the storing module 230, Buffer Size may refer to the number of stored audio packets at the receiver device 150-R as stored by the storing module 230, BUFFER_THRESHOLD may refer to the predetermined audio packet number, and WAIT_TIME may refer to the predetermined time as used by the pausing module 250. According to an embodiment of the disclosure, during the SLOW state (e.g., the slow reception phase), the received audio packets may be kept in the buffer (e.g., stored) and not played (e.g., rendered). According to an embodiment of the disclosure, the audio packet playout (e.g., rendering) may be started when the SLOW state end is determined. BUFFER_THRESHOLD may refer to a minimum number of packets in buffer to start playout of packets when in SLOW state. Increasing the BUFFER_THRESHOLD may increase the mute duration during SLOW state buffering period. If the threshold is kept small, audio may be played in broken manner.

The significance of the WAIT_TIME (e.g., a maximum time to wait after buffering a packet) before starting the playout may be understood in the following scenario. When the slow reception phase occurs towards an end of the voice call (e.g., audio transmission), the arrival of the audio packets may stop, and if the slow reception phase continues, the buffered audio data (e.g., the stored audio packets) may never get played during the definite (e.g., limited) duration of the call and may be permanently lost. Therefore, the system 200 may be configured to render the stored audio packets after waiting for the predetermined time (e.g., WAIT_TIME).

Further, if the WAIT_TIME is very small, then it might be smaller than the inter-arrival delay during the SLOW state, thus not allowing sufficient buffering during slow mode and leading to bad audio quality.

According to an embodiment of the disclosure, NORMAL_COUNT may refer to a minimum number of consecutive packets that should follow the criteria for burst or normal packet arrival. Increasing the NORMAL_CONSEC_COUNT may increase the difficulty of exiting from SLOW state. NORMAL_VAR_TH may refer to a maximum variance of packets arriving in Normal or Burst. NORMAL_TRANSIT_TH may refer to a maximum transit time difference between consecutive packets arrival normally or in burst.

An exemplary algorithm for the implementation of the system 200 may be represented in pseudo-code as below:
If current state is SLOW
   “Add received RTP packets in Buffer”
   If “burst” or “packets with normal delay” arrive:
      “Change the state to NORMAL”
      “Start playing packets in buffer”
   If Buffer Size>BUFFER_THRESHOLD:
      “Change the state to NORMAL”
      “Start playing packets in buffer”
   If Time since last buffered packet>WAIT_TIME:
      “Change the state to NORMAL”
      “Start playing packets in buffer”

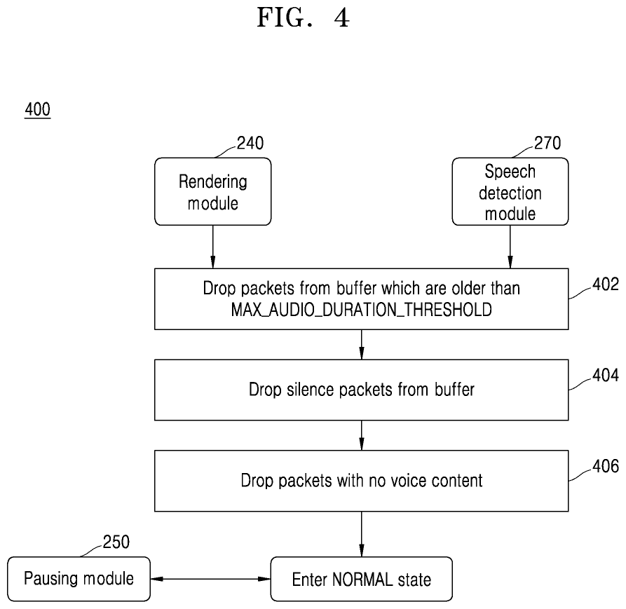

FIG. 4 illustrates process flow 400 describing the functioning of the rendering module 240 of the system 200, according to an embodiment of the disclosure. According to an embodiment of the disclosure, the storing module 230 may be configured to detect speech content associated with one or more of the audio packets received and storing the at least one of the audio packets based on the detected speech content during the slow reception phase. According to an embodiment of the disclosure, the system 200 may further include a speech detection module 270 configured to detect a characteristic of the speech content (e.g., a nature of the speech content) associated with one or more of the stored audio packets. According to an embodiment of the disclosure, the speech detection module 270 may use machine learning models or AI models for detecting a characteristic of speech content associated with the stored audio packets. For example, a voice activity detector (VAD) may be used for determining the speech content of the audio packet.

Subsequently, the rendering module 240 may be configured to drop (e.g., refrain from playing or rendering) at least one audio packet from the stored audio packets based on the detected characteristic of the speech content. According to an embodiment of the disclosure, the speech detection module 270 may be configured to detect one or more non-voice packets (e.g., one or more packets which may include sounds other than voices) and one or more silence packets (e.g., one or more packets which may include silence) from the stored audio packets. Subsequently, the rendering module 240 may be configured to drop at least one audio packet of the detected non-voice packets and of the detected silence packets.

According to an embodiment of the disclosure, the rendering module 240 may be configured to drop one or more of the detected non-voice packets. According to an embodiment of the disclosure, the rendering module 240 may be configured to drop one or more of the detected silence packets. The number of packets to be dropped may be determined dynamically to balance the call duration and the mute duration during the call. For example, in an exemplary short duration call with long slow reception phase, the rendering module 240 may be configured to drop all the detected non-voice packets and the detected silence packets in order to be able to render all the voice audio packets within the short call duration.

In an exemplary scenario, there may be stored audio packets which are already late for playing (e.g., rendering). It may be apparent that playing all the packets will cause the entire stream to get delayed and thus result in a bad communication experience for the users. However, dropping all the buffered (e.g., stored) audio packets may cause substantial loss of audio. This trade-off may be managed by setting up a threshold of audio duration and/or a number of audio packets to be stored for rendering to start again after the pausing of the rendering.

In the exemplary process flow 400, at operation 402, the rendering module 240 may be configured to drop audio packets based on a duration of the call. Further, at operation 404, the rendering module 240 may be configured to drop silence audio packets. Furthermore, at operation 406, the rendering module 240 may be configured to drop audio packets which have no voice content. According to an embodiment of the disclosure, a MAX_AUDIO_DURATION_THRESHOLD may refer to specific duration of stored audio packets, and a MAX_AUDIO_PKTS_THRESHOLD may refer to a specific number of the stored audio packets.

According to an embodiment of the disclosure, the rendering module 240 may be further configured to drop, continually or continuously, at least one audio packet from one or more predetermined sequences of the stored audio packets. The pre-determined sequences of the stored audio packets may be determined based on the duration of the slow reception phase. Furthermore, the delay may also be reduced by dropping every Nth packet even when the packet has speech content. It may be appreciated that dropping just one packet from among N speech audio packets may not cause any noticeable audio degradation for the user.

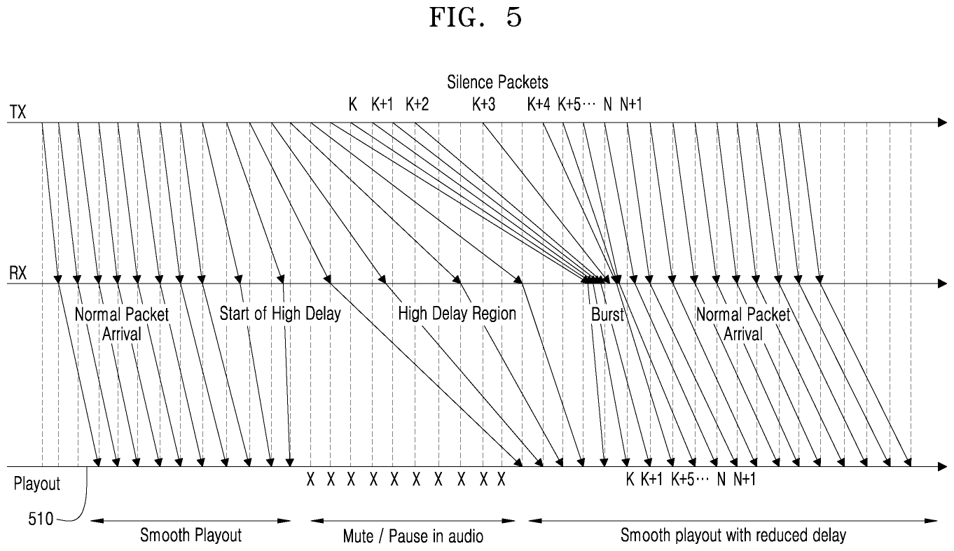

FIG. 5 illustrates an example of of reducing delay and latency recovery achieved by the system 200, according to an embodiment of the disclosure. The dropping of the silence packets (e.g., the silence packets K, K+1, etc.) or non-voice packets (e.g., the non-voice packets K+3, K+4, etc.) may reduce the end-to-end latency which would have increased due to high delay in arrival of packets. For example, in the embodiment of FIG. 5, silence packets K+2, K+3, K+4 have been dropped out of the silence packets K, K+1, . . . K+n, etc. Further, the dropping of the selected silence packets or the selected non-voice packets may ensure that speech quality of the audio at the receiver device 150-R is not affected while simultaneously reducing latency. The system 200 may be able to manage the audio packets during the high delay audio transmission and plays a playout 510 of the audio transmission at the receiver device 150-R in a smooth manner even when there is delay in the arrival of packets at the receiver device 150-R.

FIG. 6 is a flowchart illustrating a process 600, which may be an example of a process for managing audio packets during the audio transmission over the network 200-N, according to an embodiment of the disclosure. The network 200-N may be a wireless network connecting the devices 150 to each other. The audio transmission may be a wireless transmission using communication standards/protocols such as Voice over Long-Term Evolution (VoLTE) or Voice over New Radio (VoNR). The wireless transmission may be a voice call made from the transmitter device 150-T to the receiver device 150-R.

Referring to FIGS. 2-5 together, the process 600 may be performed by the receiver device 150-R, which may be, for example, a feature phone, a smartphone, or any other electronic device having audio transmission/receiving capabilities based on instructions retrieved from non-transitory computer-readable media. A computer-readable media may include machine-executable or computer-executable instructions to perform all or portions of the described method. The computer-readable media may be, for example, digital memories, magnetic storage media, such as magnetic disks and magnetic tapes, hard drives, or optically readable data storage media. The process 600 includes a series of operations depicted in FIG. 6 as operation 602 through operation 608. The process 600 may be performed by the system 200 in conjunction with one or more modules 210, the details of which are explained in conjunction with FIGS. 2-5, and the same are not repeated here for the sake of brevity. As shown in FIG. 6, the process 600 begins at operation 602.

At operation 602, the process 600 may include determining or detecting a beginning of a slow reception phase based on an audio packet reception rate associated with a plurality of audio packets received by the electronic device 150. The slow reception phase may refer to the duration of the audio transmission during which the audio packets are not received uniformly at the receiver device 150-R.

According to an embodiment of the disclosure, at operation 602, the process 600 may further include comparing the inter-arrival time delay associated with the plurality of audio packets with the minimum threshold value. Subsequently, the process 600 may include marking or detecting the beginning of the slow reception phase based on determining that the inter-arrival time delay is greater than the minimum threshold value.

According to an embodiment of the disclosure, the process 600 may further include pausing a current rendering of the plurality of audio packets based on detecting of the beginning of the slow reception phase. According to an embodiment of the disclosure, the method 600 may further include pausing a current rendering of the plurality of audio packets based on determining that a determined time from the marking or detecting of the beginning of the slow reception phase.

At operation 604, the operation 600 may further include storing at least one audio packet received during the slow reception phase from among the plurality of audio packets.

At operation 606, the operation 600 may further include determining or detecting an end of the slow reception phase based on a change in the audio packet reception rate.

According to an embodiment of the disclosure, operation 606 may further include determining or detecting a trend in transit times associated with the receiving of the plurality of audio packets and subsequently, marking or detecting the beginning of the slow reception phase and end of the slow reception phase based on the trend.

At operation 608, the process 600 may further include rendering an audio packet from among the stored at least one audio packet based on at least one of a status of the slow reception phase and a number of the stored at least one audio packet.

According to an embodiment of the disclosure, the process 600 may further include determining the number of the stored at least one audio packet. Further, at operation 608, the process 600 may further include rendering the audio packet based on a comparison between the number of the stored at least one audio packet and a determined audio packet number. According to an embodiment of the disclosure, the determined audio packet number may be pre-fed/input based on the configuration of the devices 150. According to an embodiment of the disclosure, the determined audio packet number may be dynamically determined based on a time duration having elapsed since the beginning of the slow reception phase and the current audio packet reception rate.

Furthermore, according to an embodiment of the disclosure, the process 600 may further include detecting speech content associated with the at least one audio packet, and operation 604 may further include storing the at least one of audio packet based on the detected speech content. According to an embodiment of the disclosure, the process 600 may further include detecting a characteristic of speech content associated with the stored at least one audio packet. According to an embodiment of the disclosure, the speech detection may be performed using machine learning models or AI models for detecting a characteristic of speech content associated with the stored audio packets. For example, a voice activity detector (VAD) may be used for determining the actual speech content of the audio packet.

Subsequently, operation 608 may further include dropping one or more audio packets from among the stored at least one audio packet based on the detected characteristic of the speech content. According to an embodiment of the disclosure, the process 600 may further include detecting one or more non-voice packets and one or more silence packets included in the stored at least one audio packet. Subsequently, operation 608 may further include dropping at least one of the one or more non-voice packets and the one or more silence packets. Furthermore, operation 608 may further include dropping the one or more audio packets from one or more determined sequences of the stored at least one audio packet based on a duration of the slow reception phase.

The systems, devices, and methods of the disclosure may provide various advantageous aspects of storing the received audio packets at the receiver device and dropping audio packets based on the determined speech content. As a result, the user may experience a smooth audio devoid of robotic noise. Embodiments may provide for smooth and glitch-free audio even during bad network conditions such as congestion. Embodiments may provide overall end-to-end reduction in latency and simultaneously may not compromise on the content of the audio being transmitted.

According to an embodiment of the disclosure, a method for managing audio-packets during an audio transmission may be provided. The method may include determining, by a receiver device, a beginning of a slow reception phase of the audio transmission based on a rate of audio-packets reception at the receiver device. The method may include storing, by the receiver device, at least one of the audio-packets received during the slow reception phase. The method may include determining, by the receiver device, an end of the slow reception phase based on change in the rate of audio-packets reception. The method may include rendering, by the receiver device, one or more stored audio-packets based on at least one of: a status of the slow reception phase, and a number of the stored audio-packets.

According to an embodiment of the disclosure, the determining the beginning of the slow reception phase may comprise comparing, continually, an inter-arrival time delay associated with receiving of the audio-packets at the receiver device with a predefined minimum threshold inter-arrival time delay value. The determining the beginning of the slow reception phase may comprise marking the beginning of the slow reception phase when the inter-arrival time delay is more than the predefined minimum threshold inter-arrival time delay value.

According to an embodiment of the disclosure, the method may include pausing, by the receiver device, a current rendering of audio-packets upon marking of the beginning of the slow reception phase.

According to an embodiment of the disclosure, the method may include determining, at the receiver device, the number of the stored audio-packets stored during the storing of the at least one of the audio-packets. The method may include rendering the one or more of the stored audio-packets based on a comparison of the determined number of the stored audio-packets with a predefined audio-packet number.

According to an embodiment of the disclosure, the predefined audio-packet number is determined based on a time duration having elapsed since the beginning of the slow reception phase and current rate of audio-packet reception at the receiver device.

According to an embodiment of the disclosure, the method may include pausing, by the receiver device, a current rendering of the audio-packets after elapse of a predefined time from the marking of the beginning of the slow reception phase.

According to an embodiment of the disclosure, storing the at least one of the audio-packets received during the slow reception phase may comprise detecting speech content associated with one or more of the audio-packets received. The storing of the at least one of the audio-packets may be based on the detected speech content.

According to an embodiment of the disclosure, the method may include detecting, using machine learning models, a nature of speech content associated with one or more of the stored audio-packets. The rendering of the one or more of the audio-packets may comprise dropping, based on the detected nature of the speech content, at least one audio-packet from the one or more of the stored audio-packets.

According to an embodiment of the disclosure, the detecting of the nature of the speech content may comprise detecting one or more non-voice packets and one or more silence-packets from the stored audio-packets. The rendering of the one or more of the audio-packets may comprise dropping at least one audio-packet of the detected non-voice packets and of the detected silence packets.

According to an embodiment of the disclosure, the rendering of the one or more of the audio-packets may comprise dropping, continually, at least one audio-packet from one or more predetermined sequences of the stored audio-packets, the pre-determined sequences being based on the duration of the slow reception phase.

According to an embodiment of the disclosure, the determining the end of the slow reception phase may comprise determining a trend in transit-times associated with the receiving of the audio-packets at the receiver device and marking the end of the slow reception phase based on the determined trend.

According to an embodiment of the disclosure, a system for managing audio-packets during an audio transmission may be provided. The system may include a determining module configured for determining, by a receiver device, a beginning of a slow reception phase of the audio transmission based on a rate of audio-packets reception at the receiver device. The system may include a storing module configured for storing, by the receiver device, at least one of the audio-packets received during the slow reception phase. The system may include the determining module being configured for determining, by the receiver device, an end of the slow reception phase based on change in the rate of audio-packets reception. The system may include a rendering module configured for rendering, by the receiver device, one or more stored audio-packets based on at least one of: a status of the slow reception phase, and a number of the stored audio-packets.

According to an embodiment of the disclosure, the determining module may be configured for comparing, continually, an inter-arrival time delay associated with receiving of the audio-packets at the receiver device with a predefined minimum threshold inter-arrival time delay value. The determining module may be configured for marking the beginning of the slow reception phase when the inter-arrival time delay is more than the predefined minimum threshold inter-arrival time delay value.

According to an embodiment of the disclosure, the system may include a pausing module configured for pausing, by the receiver device, a current rendering of audio-packets upon marking of the beginning of the slow reception phase.

According to an embodiment of the disclosure, the system may include a stored packet determining module configured for determining, at the receiver device, the number of the stored audio-packets stored during the storing of the at least one of the audio-packets. The rendering module may be configured for rendering the one or more of the stored audio-packets based on a comparison of the determined number of the stored audio-packets with a predefined audio-packet number.

According to an embodiment of the disclosure, the pausing module may be configured for pausing, by the receiver device, a current rendering of the audio-packets after elapse of a predefined time from the marking of the beginning of the slow reception phase.

According to an embodiment of the disclosure, the storing module may be configured for detecting speech content associated with one or more of the audio-packets received. The storing module may be configured for storing the at least one of the audio-packets based on the detected speech content during the slow reception phase comprises.

According to an embodiment of the disclosure, the system may include a speech detection module configured for detecting, using machine learning models, a nature of speech content associated with one or more of the stored audio-packets. The rendering module may be configured for dropping, based on the detected nature of the speech content, at least one audio-packet from the one or more of the stored audio-packets.

According to an embodiment of the disclosure, the speech detection module may be configured for detecting one or more non-voice packets and one or more silence-packets from the stored audio-packets. The rendering module may be configured for dropping at least one audio-packet of the detected non-voice packets and of the detected silence packets.

According to an embodiment of the disclosure, the rendering module may be configured for dropping, continually, at least one audio-packet from one or more predetermined sequences of the stored audio-packets, the pre-determined sequences being based on the duration of the slow reception phase.

According to an embodiment of the disclosure, the determining module may be configured for determining a trend in transit-times associated with the receiving of the audio-packets at the receiver device. The determining module may be configured for marking the beginning and the end of the slow reception phase based on the determined trend.

According to an embodiment of the disclosure, a method for managing audio packets during an audio transmission may be provided. The method may include detecting, by a receiver device, a beginning of a slow reception phase of the audio transmission based on an audio packet reception rate associated with a plurality of audio packets received by the receiver device. The method may include storing, by the receiver device, at least one audio packet received during the slow reception phase from among the plurality of audio packets. The method may include detecting, by the receiver device, an end of the slow reception phase based on a change in the audio packet reception rate. The method may include rendering, by the receiver device, an audio packet from among the at least one audio packet based on at least one of a status of the slow reception phase, and a number of the at least one audio packet.

According to an embodiment of the disclosure, the detecting the beginning of the slow reception phase may comprise continuously comparing an inter-arrival time delay associated with the plurality of audio packets at the receiver device with a predetermined minimum threshold value. The detecting the beginning of the slow reception phase may comprise detecting the beginning of the slow reception phase based on determining that the inter-arrival time delay greater than the predetermined minimum threshold value.

According to an embodiment of the disclosure, the method may include pausing, by the receiver device, a current rendering of the plurality of audio packets based on the detecting of the beginning of the slow reception phase.

According to an embodiment of the disclosure, the method may include determining, at the receiver device, the number of the at least one audio packet. The method may include rendering the audio packet based on a comparison between the number of the at least one audio packet and a predetermined audio packet number.

According to an embodiment of the disclosure, the predetermined audio packet number may be determined based on a time duration having elapsed since the beginning of the slow reception phase and a current audio packet reception rate at the receiver device.

According to an embodiment of the disclosure, the method may include pausing, by the receiver device, a current rendering of the plurality of audio packets based on determining that a predetermined amount of time has elapsed from the detecting of the beginning of the slow reception phase.

According to an embodiment of the disclosure, the storing of the at least one audio packet may comprise detecting a speech content associated with the at least one audio packet. The storing of the at least one audio packet may be based on the detected speech content.

According to an embodiment of the disclosure, the method may include detecting, using at least one machine learning model, a characteristic of a speech content associated with the at least one audio packet. The rendering of the audio packet may comprise dropping, based on the detected characteristic of the speech content, one or more audio packets from among the at least one audio packet.

According to an embodiment of the disclosure, the detecting of the characteristic of the speech content may comprise detecting one or more non-voice packets and one or more silence packets included in the at least one audio packet. The rendering of the audio packet may comprise dropping at least one of the one or more non-voice packets and the one or more silence packets.

According to an embodiment of the disclosure, the rendering of the audio packet may comprise continuously dropping one or more audio packets from one or more predetermined sequences of the at least one audio packet. The one or more predetermined sequences may be based on a duration of the slow reception phase.

According to an embodiment of the disclosure, the detecting of the end of the slow reception phase may comprise detecting a trend in transit times associated with the receiving of the plurality of audio packets by the receiver device, and detecting the end of the slow reception phase based on the trend.

According to an embodiment of the disclosure, an electronic device for managing audio packets during an audio transmission may be provided. The electronic device may include at least one processor. The electronic device may include memory configured to store instructions. The instructions which, when executed by the at least one processor, individually or collectively, cause the at least one processor to detect a beginning of a slow reception phase of the audio transmission based on an audio packet reception rate associated with a plurality of audio packets received by the receiver device. The instructions which, when executed by the at least one processor, individually or collectively, cause the at least one processor to store at least one audio packet received during the slow reception phase from among the plurality of audio packets. The instructions which, when executed by the at least one processor, individually or collectively, cause the at least one processor to detect an end of the slow reception phase based on a change in the audio packet reception rate. The instructions which, when executed by the at least one processor, individually or collectively, cause the at least one processor to render an audio packet from among the at least one audio packet based on at least one from among a status of the slow reception phase, and a number of the at least one audio packet.

According to an embodiment of the disclosure, the instructions, when executed by the at least one processor, individually or collectively, further cause the at least one processor to continuously compare an inter-arrival time delay associated with the plurality of audio packets at a receiver device with a predetermined minimum threshold value. The instructions which, when executed by the at least one processor, individually or collectively, cause the at least one processor to detect the beginning of the slow reception phase based on determining that the inter-arrival time delay is greater than the predetermined minimum threshold value.

According to an embodiment of the disclosure, the instructions, when executed by the at least one processor, individually or collectively, further cause the at least one processor to pause a current rendering of the plurality of audio packets based on the detecting of the beginning of the slow reception phase.

According to an embodiment of the disclosure, the instructions, when executed by the at least one processor, individually or collectively, further cause the at least one processor to determine the number of the at least one audio packet. The instructions which, when executed by the at least one processor, individually or collectively, cause the at least one processor to render the audio packet based on a comparison between the number of the at least one audio packet and a predetermined audio packet number.

According to an embodiment of the disclosure, the predetermined audio packet number is determined based on a time duration having elapsed since the beginning of the slow reception phase and a current audio packet reception rate at the receiver device.

According to an embodiment of the disclosure, the instructions, when executed by the at least one processor, individually or collectively, further cause the at least one processor to pause a current rendering of the plurality of audio packets based on determining that a predetermined amount of time has elapsed from the detecting of the beginning of the slow reception phase.

According to an embodiment of the disclosure, the instructions, when executed by the at least one processor, individually or collectively, further cause the at least one processor to detect a speech content associated with the at least one audio packet. The instructions which, when executed by the at least one processor, individually or collectively, cause the at least one processor to store the at least one audio packet based on the detected speech content during the slow reception phase comprises.

According to an embodiment of the disclosure, the instructions which, when executed by the at least one processor, individually or collectively, cause the at least one processor to detect, using at least one machine learning model, a characteristic of a speech content associated with the at least one audio packet. The instructions which, when executed by the at least one processor, individually or collectively, cause the at least one processor to drop at least one audio packet from among the at least one audio packet based on the detected characteristic of the speech content.

According to an embodiment of the disclosure, the instructions, when executed by the at least one processor, individually or collectively, cause the at least one processor to detect one or more non-voice packets and one or more silence packets included in the at least one audio packet. The instructions which, when executed by the at least one processor, individually or collectively, cause the at least one processor to drop at least one of the one or more non-voice packets and the one or more silence packets.

According to an embodiment of the disclosure, the instructions, when executed by the at least one processor, individually or collectively, further cause the at least one processor to continuously drop one or more audio packets from one or more predetermined sequences of at least one audio packet. The one or more predetermined sequences being are on a duration of the slow reception phase.

According to an embodiment of the disclosure, the instructions, when executed by the at least one processor, individually or collectively, further cause the at least one processor to detect a trend in transit times associated with the receiving of the plurality of audio packets by the receiver device. The instructions which, when executed by the at least one processor, individually or collectively, cause the at least one processor to detect the beginning of the slow reception phase and the end of the slow reception phase based on the determined trend.

According to an embodiment of the disclosure, the detecting of the beginning of the slow reception phase may comprise comparing an inter-arrival time delay associated with the plurality of audio packets with a minimum threshold value. The detecting of the beginning of the slow reception phase may comprise detecting the beginning of the slow reception phase based on determining that the inter-arrival time delay is greater than the minimum threshold value.

According to an embodiment of the disclosure, the method may include pausing a current rendering of the plurality of audio packets based on the detecting of the beginning of the slow reception phase.

According to an embodiment of the disclosure, the determined audio packet number may be determined based on a time duration having elapsed since the beginning of the slow reception phase and a current audio packet reception rate.

According to an embodiment of the disclosure, the method may include pausing a current rendering of the plurality of audio packets based on determining that a determined amount of time has elapsed from the detecting of the beginning of the slow reception phase.

According to an embodiment of the disclosure, the storing of the at least one audio packet may comprise detecting a speech content associated with the at least one audio packet. The storing of the at least one audio packet may comprise storing the at least one audio packet based on the detected speech content.

According to an embodiment of the disclosure, the method may include detecting a characteristic of the speech content associated with the stored at least one audio packet. The rendering of the audio packet may comprise dropping one or more audio packets from among the stored at least one audio packet based on the detected characteristic of the speech content.

According to an embodiment of the disclosure, the detecting of the characteristic of the speech content may comprise detecting one or more non-voice packets and one or more silence packets included in the stored at least one audio packet. The rendering of the audio packet may comprise dropping at least one of the one or more non-voice packets and the one or more silence packets.

According to an embodiment of the disclosure, the rendering of the audio packet may comprise dropping the one or more audio packets from one or more determined sequences of the stored at least one audio packet based on a duration of the slow reception phase.

According to an embodiment of the disclosure, the method may include detecting a trend in transit times associated with the receiving of the plurality of audio packets. The method may include detecting the beginning of the slow reception phase and the end of the slow reception phase based on the trend.

According to an embodiment of the disclosure, the at least one processor individually or collectively executes the instructions to cause the electronic device to compare an inter-arrival time delay associated with the plurality of audio packets with a minimum threshold value. The at least one processor individually or collectively executes the instructions to cause the electronic device to detect the beginning of the slow reception phase based on determining that the inter-arrival time delay is greater than the minimum threshold value.

According to an embodiment of the disclosure, wherein the at least one processor individually or collectively executes the instructions to further cause the electronic device to pause a current rendering of the plurality of audio packets based on the detecting of the beginning of the slow reception phase.

According to an embodiment of the disclosure, the at least one processor individually or collectively executes the instructions to cause the electronic device to determine the number of the stored at least one audio packet. The at least one processor individually or collectively executes the instructions to cause the electronic device to render the audio packet based on a comparison between the number of the stored at least one audio packet and a determined audio packet number.

According to an embodiment of the disclosure, the at least one processor individually or collectively executes the instructions to cause the electronic device to pause a current rendering of the plurality of audio packets based on determining that a determined amount of time has elapsed from the detecting of the beginning of the slow reception phase.

According to an embodiment of the disclosure, the at least one processor individually or collectively executes the instructions to cause the electronic device to detect a speech content associated with the at least one audio packet. The at least one processor individually or collectively executes the instructions to cause the electronic device to store the at least one audio packet based on the detected speech content.

According to an embodiment of the disclosure, the at least one processor individually or collectively executes the instructions to further cause the electronic device to detect a characteristic of the speech content associated with the stored at least one audio packet. The at least one processor individually or collectively executes the instructions to cause the electronic device to drop one or more audio packets from among the stored at least one audio packet based on the detected characteristic of the speech content.

According to an embodiment of the disclosure, the at least one processor individually or collectively executes the instructions to cause the electronic device to detect one or more non-voice packets and one or more silence packets included in the stored at least one audio packet. The at least one processor individually or collectively executes the instructions to cause the electronic device to drop at least one of the one or more non-voice packets and the one or more silence packets.

According to an embodiment of the disclosure, the at least one processor individually or collectively executes the instructions to cause the electronic device to drop the one or more audio packets from one or more determined sequences of the stored at least one audio packet based on a duration of the slow reception phase.

According to an embodiment of the disclosure, the at least one processor individually or collectively executes the instructions to further cause the electronic device to detect a trend in transit times associated with the receiving of the plurality of audio packets. The at least one processor individually or collectively executes the instructions to cause the electronic device to detect the beginning of the slow reception phase and the end of the slow reception phase based on the trend.

While specific language has been used to describe the disclosure, any limitations arising on account of the same are not intended. As would be apparent to a person in the art, various working modifications may be made to the method in order to implement the inventive concept as taught herein.

The drawings and the foregoing description give examples of embodiments. Those skilled in the art will appreciate that one or more of the described elements may well be combined into a single functional element. According to an embodiment of the disclosure, certain elements may be split into multiple functional elements, and elements from one embodiment may be added to another embodiment. For example, orders of processes described herein may be changed and are not limited to the manner described herein.

In addition, the actions or operations depicted in any flow diagram need not be implemented in the order shown; nor do all of the acts necessarily need to be performed. Also, those acts that are not dependent on other acts may be performed in parallel with the other acts. The scope of embodiments is not limited by these specific examples. Numerous variations, whether explicitly given in the specification or not, such as differences in structure, dimension, and use of material, are possible without departing from the scope of the disclosure, which is at least as broad as given by the following claims.

Benefits, other advantages, and solutions to problems are described above with regard to specific embodiments. However, the benefits, advantages, solutions to problems, and any component or components that may cause any benefit, advantage, or solution to occur or become more pronounced are not to be construed as a critical, required, or essential feature or component of any or all the claims.

What is claimed is:

1. A method performed by an electronic device, the method comprising:
detecting a beginning of a slow reception phase based on an audio packet reception rate associated with a plurality of audio packets received by the electronic device;
storing at least one audio packet received during the slow reception phase from among the plurality of audio packets;
detecting an end of the slow reception phase based on a change in the audio packet reception rate; and
rendering an audio packet from among the stored at least one audio packet based on at least one of a status of the slow reception phase, and a number of the stored at least one audio packet.

2. The method of claim 1, wherein the detecting of the beginning of the slow reception phase comprises:
comparing an inter-arrival time delay associated with the plurality of audio packets with a minimum threshold value; and
detecting the beginning of the slow reception phase based on determining that the inter-arrival time delay is greater than the minimum threshold value.

3. The method of claim 1, further comprising:
pausing a current rendering of the plurality of audio packets based on the detecting of the beginning of the slow reception phase.

4. The method of claim 1, wherein the rendering of the audio packet comprises:
determining the number of the stored at least one audio packet; and
rendering the audio packet based on a comparison between the number of the stored at least one audio packet and a determined audio packet number.

5. The method of claim 4, wherein the determined audio packet number is determined based on a time duration having elapsed since the beginning of the slow reception phase and a current audio packet reception rate.

6. The method of claim 1, wherein the storing of the at least one audio packet comprises:
detecting a speech content associated with the at least one audio packet; and
storing the at least one audio packet based on the detected speech content.

7. The method claim 6, further comprising:
detecting a characteristic of the speech content associated with the stored at least one audio packet,
wherein the rendering of the audio packet comprises dropping one or more audio packets from among the stored at least one audio packet based on the detected characteristic of the speech content.

8. The method of claim 7,
wherein the detecting of the characteristic of the speech content comprises detecting one or more non-voice packets and one or more silence packets included in the stored at least one audio packet, and
wherein the rendering of the audio packet comprises dropping at least one of the one or more non-voice packets and the one or more silence packets.

9. The method of claim 7, wherein the rendering of the audio packet comprises:
dropping the one or more audio packets from one or more determined sequences of the stored at least one audio packet based on a duration of the slow reception phase.

10. The method of claim 1, further comprising:
detecting a trend in transit times associated with the receiving of the plurality of audio packets; and
detecting the beginning of the slow reception phase and the end of the slow reception phase based on the trend.

11. An electronic device comprising:
memory storing instructions; and
at least one processor operatively coupled to the memory and comprising processing circuitry,
wherein the at least one processor individually or collectively executes the instructions to cause the electronic device to:
detect a beginning of a slow reception phase based on an audio packet reception rate associated with a plurality of audio packets received by the electronic device;
store at least one audio packet received during the slow reception phase from among the plurality of audio packets;
detect an end of the slow reception phase based on a change in the audio packet reception rate; and
render an audio packet from among the stored at least one audio packet based on at least one of a status of the slow reception phase, and a number of the stored at least one audio packet.

12. The electronic device of claim 11, wherein the at least one processor individually or collectively executes the instructions to cause the electronic device to:
compare an inter-arrival time delay associated with the plurality of audio packets with a minimum threshold value; and
detect the beginning of the slow reception phase based on determining that the inter-arrival time delay is greater than the minimum threshold value.

13. The electronic device of claim 11, wherein the at least one processor individually or collectively executes the instructions to further cause the electronic device to:
pause a current rendering of the plurality of audio packets based on the detecting of the beginning of the slow reception phase.

14. The electronic device of claim 11, wherein the at least one processor individually or collectively executes the instructions to cause the electronic device to:
determine the number of the stored at least one audio packet; and
render the audio packet based on a comparison between the number of the stored at least one audio packet and a determined audio packet number.

15. The electronic device of claim 14, wherein the determined audio packet number is determined based on a time duration having elapsed since the beginning of the slow reception phase and a current audio packet reception rate.

16. The electronic device of claim 11, wherein the at least one processor individually or collectively executes the instructions to further cause the electronic device to:
detect a characteristic of a speech content associated with the stored at least one audio packet; and
drop one or more audio packets from among the stored at least one audio packet based on the detected characteristic of the speech content.

17. The electronic device of claim 16, wherein the at least one processor individually or collectively executes the instructions to cause the electronic device to:
detect one or more non-voice packets and one or more silence packets included in the stored at least one audio packet; and
drop at least one of the one or more non-voice packets and the one or more silence packets.

18. The electronic device of claim 16, wherein the at least one processor individually or collectively executes the instructions to cause the electronic device to:
drop the one or more audio packets from one or more determined sequences of the stored at least one audio packet based on a duration of the slow reception phase.

19. The electronic device of claim 11, wherein the at least one processor individually or collectively executes the instructions to further cause the electronic device to:
detect a trend in transit times associated with the receiving of the plurality of audio packets; and
detect the beginning of the slow reception phase and the end of the slow reception phase based on the trend.

20. A non-transitory computer-readable storage medium configured to store at least one instruction, which, when executed by at least one processor individually or collectively, cause the at least one processor to perform the method of any one of claim 1.
